(19) United States
(12) Patent Application Publication
(10) Pub. No.: US 2026/0358228 A1
(43) Pub. Date: Nov. 12, 2026

(54) SYSTEMS AND METHODS FOR WATER VAPOR TRANSMISSION RATE TESTING

(71) Applicant: ADDIUM, INC., Pullman, WA (US)

(72) Inventors: Mary T. GALLOWAY, Pullman, WA (US); Gregory M. KELLEY, Pullman, WA (US); Benjamin WALDEN, Moscow, ID (US)

(21) Appl. No.: 19/204,160

(22) Filed: May 9, 2025

(51) Int. Cl. G01N 15/08

(52) U.S. Cl. CPC G01N 15/0806; G01N 15/082

(57) ABSTRACT

A container for testing a water vapor transmission rate (WVTR) of a sample material is provided. The container includes a container housing defining an internal chamber, and a retaining ring attached to an upper portion of the container housing and configured to retain a sample material between the retaining ring and the container housing. A first gasket is disposed between the retaining ring and the container housing and configured to be disposed against an upper surface of the sample material. The retaining ring is configured to compress the first gasket in a first direction and in a second direction against the container housing in response to attachment of the retaining ring to the container housing so as to hermetically seal the internal chamber about a perimeter portion of the container housing.

### TECHNICAL FIELD

The present disclosure relates to scientific instruments and more particularly to testing equipment for determining vapor transmission rates of material samples.

### BACKGROUND

The water vapor transmission rate (WVTR) of a material is a property of the material that indicates its permeability for moisture penetration. The WVTR of a material is often used in construction, packaging or textile design to evaluate the material's suitability as a coating, film, membrane, or other moisture barrier material.

The American Society for Testing and Materials (ASTM) provides standards for testing materials and environments. ASTM E96 is a standardized test method commonly used to measure and characterize the WVTR of test materials. This standardized test is commonly applied to characterize the WVTR of everyday materials such films, membranes, coatings, and so on, to evaluate their effectiveness as moisture barriers in everyday use and to allow for standardized comparisons between different materials. The WVTR of a material is commonly expressed in grams of water per square meter per day (g/m²/day).

ASTM E96 provides two primary methods for determining WVTR, including a dry cup test, wherein a desiccant is positioned within a fixture and an external vapor source, and the material is positioned between the desiccant and the vapor source. The weight of the desiccant is measured over time to determine the rate of transmission of moisture through the sample material as it is absorbed by the desiccant. The other primary WVTR testing method is the wet cup test, utilizing a water source within a fixture and a dry chamber, with the sample material positioned between the two. In the wet cup test, the weight of the water source is tracked over time to determine the rate of transmission of moisture through the sample material to the dry chamber.

There is a constant need for improvements to equipment, such as improvements to improve the accuracy, speed, and reliability of the WVTR tests.

### BRIEF DESCRIPTION OF THE DRAWINGS

FIG. 1 illustrates an example system for WVTR testing.

FIG. 2 illustrates an example container of the system of FIG. 1.

FIG. 3 illustrates an exploded view of the container of FIG. 2.

FIG. 4 illustrates a perspective section view of the container of FIG. 2 in an assembled configuration.

FIG. 5 illustrates a side section view of the container of FIG. 2 in an uncompressed state.

FIG. 6 illustrates a side section view of the container of FIG. 2 in a compressed state.

FIG. 7 illustrates a bottom view of the retaining ring of the container of FIG. 2.

FIG. 8 illustrates a side section view of the retaining ring of the container of FIG. 2.

FIG. 9 illustrates an exploded view of an example embodiment of a container.

FIG. 10 illustrates an example system for WVTR testing.

FIG. 11 illustrates a side section view of the system of FIG. 10 as taken through section lines 11-11 in FIG. 10.

FIG. 12 illustrates an exploded view of the system of FIG. 10.

### DETAILED DESCRIPTION

To ensure accuracy during a test, leaks, gaps, and pores between the specimen and test cup should be avoided. Unintended openings in the material can create leakage points, leading to artificially high moisture transmission rates that may not accurately reflect a true WVTR of the sample material.

For some materials and samples, creating such a seal can be more of a challenge than others. For example, some materials such as fibers, textiles, natural materials, etc., can have naturally porous and/or non-uniform structure and surface characteristics. In cases where a specimen has a sufficient thickness, it can be difficult to seal the specimen around a lateral face, and moisture leakage may occur and may be measured through an unintended dimension (e.g., through an edge of the material).

Embodiments of the present disclosure relate to containers for WVTR testing that include containers, retaining rings, and gaskets/seals configured to minimize or eliminate leakage of flow around the sample material so that WVTR tests more accurately indicate the WVTR of the sample material. To do so, gaskets and retaining rings may be provided that ensure complete sealing of the sample material around its entire perimeter/circumference of its top surface and around any fasteners or other attachment devices used to hold the sample material to the testing container.

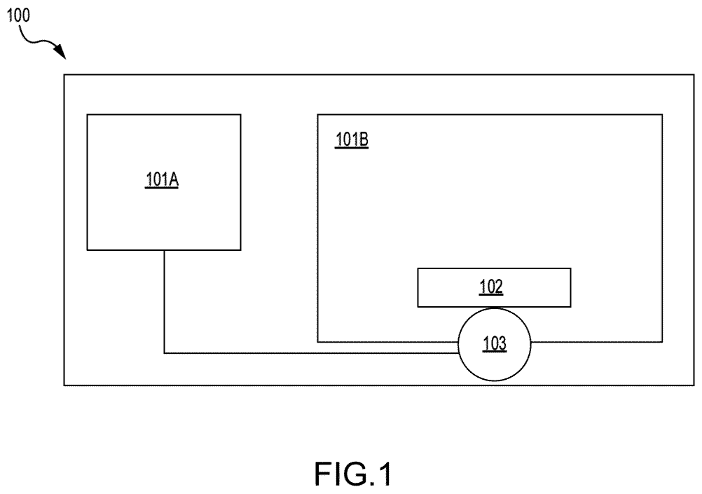

FIG. 1 illustrates a schematic view of an example system 100 for conducting a WVTR test (e.g., in accordance with ASTM E96) to measure the moisture absorption properties of a test material. As seen in the illustrated embodiment, system 100 includes a test chamber 101B in which the relative humidity (RH) and/or temperature can be controlled, a cup or container 102 to hold a desiccant (or moisture source) and the test specimen, and a weight sensor 103 and control system 101A for recording weight via the sensor 103 over time.

In some cases, test chamber 101B can be a controlled and/or sealed environment in which the relative humidity level can be managed. For example, in some cases, test chamber 101B can include a controllable source of humid air (e.g., a saturated salt solution exposed to the test chamber 101B). In some cases, test chamber 101B can include appropriate sensors such as humidity, temperature, and or weight sensors. The test chamber 101B can be defined within an external housing of the system 100. In some examples, a door or lid of the test chamber 101B can be operated to open and close the test chamber 101B. When closed, the test chamber 101B may be sealed from the outside environment so that its internal temperature, RH, pressure, etc. can be monitored and controlled by the system 100. The test chamber 101B may be defined in a housing of a desktop or benchtop testing device configured to receive and test at least one container 102 and corresponding sample material at a time, with the container 102 being removable from the test chamber 101B between tests in order to replace sample materials attached to the container 102, replace desiccants or moisture sources in the container 102, and similar activities.

In some cases, a set of controls (e.g., control system 101A) can be used to control the relative humidity and/or temperature of test chamber 101B. The control system 101A may include a computing device (e.g., including a processor, memory device, input-output interface, user operable interface/controls, and similar components) configured to measure, track, and record the temperature, pressure, RH, weight sensor output (e.g., from sensor 103), and/or similar properties of the test. In some examples, the control system 101A may generate and report the WVTR of the sample material to a user via a user interface (e.g., display screen, audio speaker, etc.)

A sample material to be tested with system 100 can include construction materials, packaging, polymers, textiles, fibrous materials, food, and so on. In some examples, the sample material can be formed (e.g., cut, punched, clipped, etc.) into a disk shape or a shape corresponding to the upper perimeter shape of the container 102 and attached to the container 102 for testing using attachment devices (e.g., fasteners, clamps, etc.), at least one gasket, and a retention ring that distributes load on the sample material, as described in further detail elsewhere herein.

In some cases, container 102 (and a sample material therein) of system 100 can be a cup, container, or fixture configured and designed and hold the specimen to be tested. Additionally, as discussed, container 102 can further include a desiccant (for dry cup tests) or a water source (for wet cup tests). As will be further discussed, the sample material can be positioned on, in, within, or against container 102 such that the sample material can be or serve as a barrier between the internal contents of the container 102 and the test chamber 101B. Such a configuration can allow moisture to transfer solely through the sample material so that its rate of transmission can be measured over time.

To enhance the accuracy of the test results, container 102 and the sample material can be securely sealed to prevent unintended leakage. Such a seal can include an edge seal around a perimeter, circumference, or exterior of the sample material. Container 102 can be formed from steel, aluminum, a coated thermoplastic, or any other suitable material.

In some cases, the sample material and/or container 102 can be removed from test chamber 101B for weighing, e.g., on a microscale or similar instrument external to system 100. However, in some cases, a scale can be included within test chamber 101B. Weight sensor 103 can be included within or adjacent to the test chamber 101B for measuring the weight of the container 102, its contents, and/or the sample material without moving the container 102. In some cases, weight sensor 103 can be a high-precision scale or microbalance to actively measure weight changes in container 102 and/or sample material as vapor is absorbed or desorbed. In some cases, system 100 can actively measure and/or record weight gained and/or lost through the sample material using control system 101A. In some cases, control system 101A can integrate or communicate with external computing devices or cloud-based platforms, e.g., for remote monitoring and data logging.

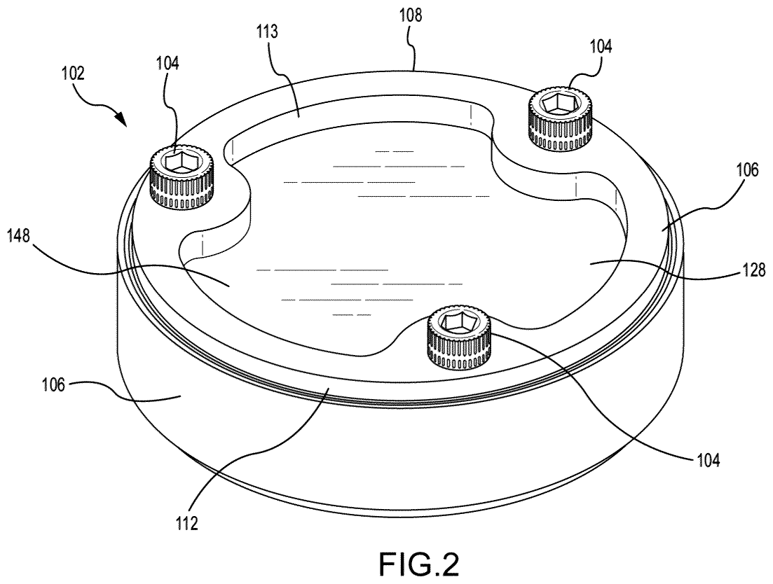

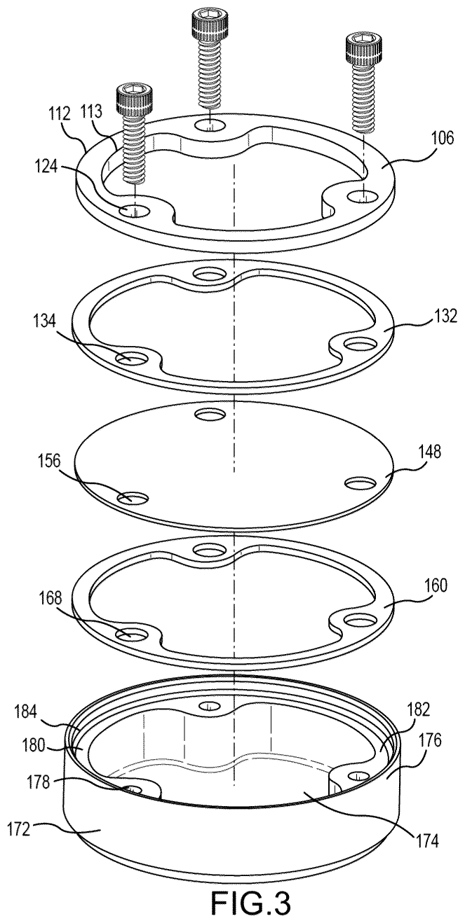

FIG. 2 illustrates a perspective view of an example container 102 of FIG. 1 according to an example embodiment. FIG. 3 shows an exploded view of the container 102, its components, and a sample material. Container 102 may retain a sample material 148 using a retaining ring 106. In some cases, the container 102 and/or retaining ring 106 can retain or secure sample material 148 such that sample material 148 is secured in place and acts as a barrier between an internal chamber 174 (see FIG. 3) of the container housing 172 (e.g., a cup, bucket, or receptacle) and the external environment to container 102 (e.g., test chamber 101B).

As indicated above, in some cases, the sample material 148 can be any relevant material for testing. For instance, in some cases, sample material 148 can be or include food packaging, textiles, construction materials, and so on. As shown in FIG. 3, the sample material 148 may be formed into or cut to fit a shape of a top end of the container housing 172. For example, the sample material 148 may be formed to conform with and follow the shape of the shelf 180 and vertical surface 184 of the container housing 172 to completely cover the internal chamber 174. The sample material 148 may include apertures or openings (e.g., holes 156) to receive a shaft of a fastener holding the sample material 148 to the container 102 and aligning the sample material 148 with other openings in other parts of the container 102.

In some cases, retaining ring 106 can provide a compressive force to the sample material 148 (e.g., directly or via a gasket 132) and may be tightened or sealed by attachment to container housing 172. In some cases, retaining ring 106 can be tightened against sample material 148 and/or upper gasket 132 to provide a hermetic, airtight, and/or fluid-tight seal around an entire outer circumferential surface, upper surface, and/or lower surface of sample material 148. Otherwise stated, in some cases, retaining ring 106 and any included gaskets can provide a seal against sample material 148 in a vertical direction, a lateral direction, and/or a circumferential direction around the edge of the container housing 172. Thus, in some cases, retaining ring 106 can provide a seal against sample material 148 in three dimensions or three orthogonal directions, as further explained elsewhere herein.

As discussed, sample material 148 can be held in place, or against container housing 172, via retaining ring 106. Retaining ring 106 can include a central gap 128 (e.g., a top opening, aperture, or through-hole) in its upper surface 108 to expose sample material 148 to the controlled environment. Gap 128 can be defined by an inner circumferential surface 113 of retaining ring 106. An upper surface 108 of retaining ring 106 can extend between inner circumferential surface 113 and an outer circumferential surface 112 of retaining ring 106. Pressure may be applied to the upper surface 108 to drive retaining ring 106 downward to seal the circumference of sample material 148 relative to container housing 172.

As will be further discussed below, retaining ring 106 can be adhered, coupled, attached, or otherwise pressed (e.g., tightened down) into an upper portion of container housing 172. In some cases, retaining ring 106 can be attached to container housing 172 via one or more compression screws 104. As shown, compression screw(s) 104 can compress retaining ring 106 into container housing 172. Accordingly, a hermitic seal can be formed around an exterior or perimeter portion of sample material 148.

Accordingly, vapor is transmitted through the exposed upper surface of sample material 148. As discussed, container housing 172 can include an internal chamber 174 (seen in FIG. 3) to house a desiccant or moisture source. A desiccant or moisture source within container housing 172 can influence or enhance the transmission of vapor through the exposed surface of sample material 148. The desiccant may include a highly hygroscopic material such as anhydrous calcium chloride, silica gel, activated alumina, clays, similar materials, or combinations thereof that absorb moisture consistently and are non-volatile. The moisture source can include distilled or deionized water, salt solutions, glycerol-water solutions, similar materials, or combinations thereof.

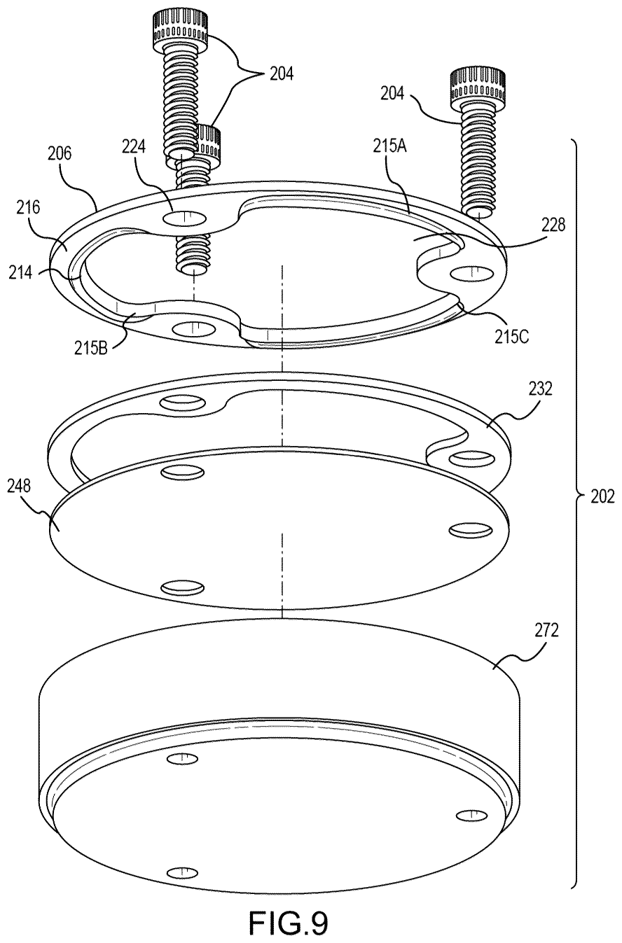

As shown in FIG. 3, container 102 may comprise an upper assembly (e.g., formed by retaining ring 106, upper gasket 132, sample material 148, and a lower gasket 160) which rests on, is pressed onto, or is otherwise inserted into a shelf 180 of container housing 172. (In some embodiments, only the upper gasket 132 may be used, to the exclusion of the lower gasket 160. See, e.g., FIG. 9 and its related descriptions herein.)

As seen, shelf 180 can extend around an upper perimeter portion of container 102 (e.g., extending circumferentially around the upper end of container 102). An intermediate vertical surface 184 (i.e., a vertically oriented generally ring-shaped surface extending around container housing 172 and placed intermediately between internal chamber 174 and the environment surrounding the container housing 172) and an intermediate lateral surface 182 (i.e., a laterally oriented generally ring-shaped surface intermediately between a top edge of the container housing 172 and a bottom surface of the internal chamber 174) may be formed by the container housing 172 at shelf 180. In some cases, shelf 180 can support the upper assembly using both intermediate lateral surface 182 and intermediate vertical surface 184.

In some cases, the compression screws used to seal upper assembly to container housing 172 can be disposed through hole 124, through hole 134, through hole 156, through hole 168, and into threaded hole 178 of container housing 172. The upper assembly may include at least three holes 124, 134, 156, 168 in each component so that the screws 104 evenly distribute pressure against the sample material 148 and gaskets 132, 160 when the screws 104 are tightened down evenly. In some examples, two screws and two associated holes may be used in the upper assembly, or more than three screws and more than three associated holes may be used. Using more than three screws 104 can more evenly distribute pressure in the upper assembly but may also reduce the available area of the internal chamber 174 due to the container housing 172 needing additional screw holes 178. Accordingly, using three screws 104 can beneficially optimize providing even load distribution and providing a relatively large internal chamber 174.

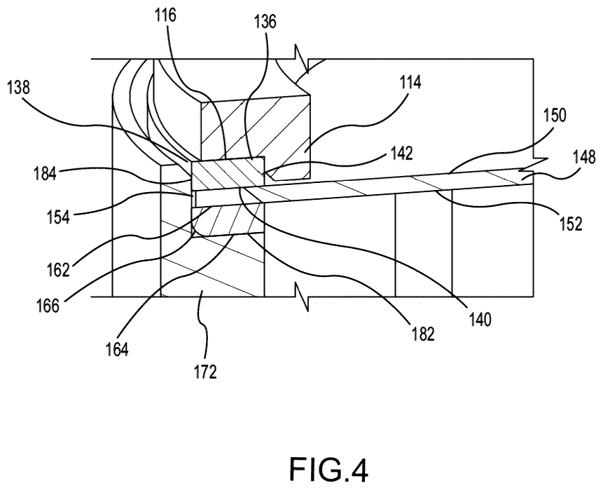

FIG. 4 illustrates a perspective side section view of container 102 of FIG. 2 in an assembled configuration. The upper assembly, formed by retaining ring 106, upper gasket 132, sample material 148, and lower gasket 160, rests on intermediate lateral surface 182 of shelf 180 of container housing 172.

The gaskets 132, 160, when compressed, hermetically seal an outer circumferential surface or outer surface 154 of sample material 148 by forming circumferential/perimeter sealing contact against intermediate vertical surface 184. In some cases, the combined outer circumferential surface or perimeter of the upper assembly (e.g., formed by retaining ring 106, upper gasket 132, sample material 148, and a lower gasket 160) can be sealed as a unit or monolithic body at the interfaces between the retaining ring 106 and the container housing 172.

The upper gasket 132 can seal can form a first seal in a horizontal or lateral direction (e.g., the radial direction relative to a vertical axis extending centrally through the container housing 172), and a second seal in the vertical or longitudinal direction (e.g., against intermediate lateral surface/downward-facing/bottom surface 116 of retaining ring 106. Additionally, the seals (both vertical and/or lateral seals) can extend around an upper perimeter portion or circumferential portion of container housing 172.

As shown in FIGS. 4 and 6, upper gasket 132 can be positioned between retaining ring 106 and sample material 148. In some cases, retaining ring 106 can include a ridge ring 114 or an otherwise lower circumferential edge that extends around retaining ring 106 and that protrudes downward from an intermediate lateral surface 116. The ridge ring 114 can therefore extend downward from a downward-facing surface of retaining ring 106 that faces the top surface 150 of sample material 148, and the upper gasket 132 can be positioned sandwiched between sample material 148 and retaining ring 106.

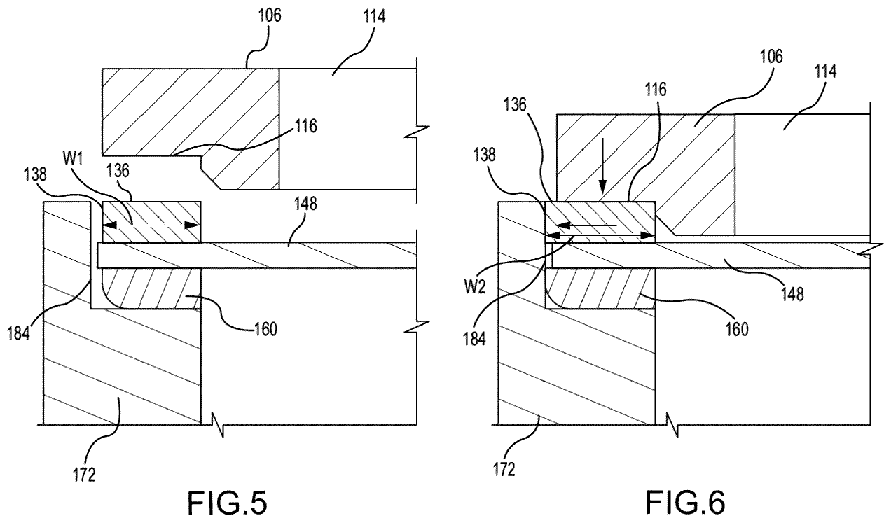

FIGS. 5-6 illustrate side section views of the container 102 at the interface between the shelf 180 and the upper assembly. FIG. 5 shows the interface prior to installation of the retaining ring 106, as indicated by the gap between the intermediate lateral surface 116 of retaining ring 106 and the top surface 136 of upper gasket 132. In FIG. 5, the upper gasket 132 and lower gasket 160 are uncompressed and at rest with sample material 148 sandwiched between the gaskets. Accordingly, the upper gasket 132 and lower gasket 160 can have an uncompressed lateral width dimension W1 and an uncompressed vertical height dimension (defined between upper surface 136 and lower surface 140 for upper gasket 132 and defined between an upper surface 162 and a lower surface 164 for lower gasket 160). An inner circumferential surface 142 of the upper gasket 132 is out of contact with the retaining ring 106, and the outer circumferential surface 138 of the upper gasket 132 is out of contact with the intermediate vertical surface, as shown by the gap in FIG. 5.

The gap or open space between the inner diameter of the intermediate vertical surface 184 of the container housing 172 and the outer diameters of the upper gasket 132, sample material 148, and lower gasket 160 can make the upper gasket 132, sample material 148, and lower gasket 160 easier to install to the container housing 172 since they are smaller than the inner diameter of the intermediate vertical surface 184. This can also be beneficial because, as shown in FIG. 6, the outer diameters of at least the gaskets 132, 160 can be evenly compressed against the intermediate vertical surface 184 to ensure a consistent hermetic seal around the outer circumferences of at least the gaskets 132, 160, thereby reducing the possibility of leaks due to installation error, misalignment of parts, or inconsistent pressure on the gaskets 132, 160.

In order to install the retaining ring 106, the retaining ring 106 may be vertically moved downward over the upper gasket 132 so that the ridge ring 114 slides within the inner circumferential surface 142 of the upper gasket 132, as shown by the vertical arrow in FIG. 6. Retaining ring 106 may include a sloped, rounded, beveled, or chamfered radially outer edge on the ridge ring 114 to help guide (e.g., funneling) the retaining ring 106 to be centered relative to the upper gasket 132, with the ridge ring 114 being horizontally aligned with the opening through the upper gasket 132 in both lateral directions. This alignment can help limit or eliminate the possibility of uneven application of pressure, such as if the ridge ring 114 were to contact the top surface of the upper gasket 132 due to improper positioning of the upper gasket 132 relative to the retaining ring 106. Installation of the retaining ring 106 may also include fastening down the retaining ring 106 (e.g., using screws 104), thereby applying pressure to the gaskets 132, 160 and sealing circumferentially around the edges of the sample material 148.

The vertical compression of the upper gasket 132 against the retaining ring 106 (i.e., reducing the height of the upper gasket 132, as indicated by the vertical arrow in FIG. 6), combined with horizontal/lateral expansion of the upper gasket 132 against the intermediate vertical surface 184 (e.g., expansion of the upper gasket 132 to width W2, as indicated in FIG. 6) may hermetically seal the perimeter/circumference of the sample material 148 so that fluid, vapor, or gas cannot escape or leak through the outer perimeter of the sample material 148 at the interface of the upper gasket 132 and the container housing 172 or retaining ring 106. Accordingly, this dual sealing or sealing in two planes (i.e., at the horizontal plane of intermediate lateral surface 116 and at the vertical cylindrical boundary defined by intermediate vertical surface 184) can ensure that any transmission of water or other vapor from the internal chamber 174 to the outer test chamber 101B is limited to passage directly through the sample material 148.

To ensure a consistent and effective seal at intermediate vertical surface 184 and outer surface 138 of gasket 132, the ridge ring 114 provides rigid support to the upper gasket 132 at inner radial surface 142, thereby ensuring that lateral expansion of the upper gasket 132 is predominantly laterally/radially outward, as indicated by the left-directed arrow in FIG. 6. Thus, compression by the retaining ring 106 does not cause the upper gasket 132 to slide radially inward due to interference between the inner radial surface 142 and the ridge ring 114. The pressure applied to the upper gasket 132 by the ridge ring 114 can also provide a hermetic seal at the interface between the surfaces of the ridge ring 114 and the upper gasket 132.

The retaining ring 106 is pressed onto the upper gasket 132 and is shown in a fully installed state in FIG. 6. When the container is assembled, retaining ring 106 can also provide downward compressive pressure via upper gasket 132 to sample material 148 and/or lower gasket 160. In some cases, such a compressive force can cause uncompressed width W1 of the lower gasket 160 to expand to compressed width W2 of lower gasket 160. In some cases, the unexpanded and expanded widths can correspond to an outer diameter or radius of the compressed gasket. The lower gasket 160 can have the same uncompressed and compressed inner and outer diameters as the upper gasket 132 or can be wider or narrower than the upper gasket 132 in either inner or outer diameter dimension. The lower gasket 160 can provide additional or redundant security to the hermetic sealing at the shelf 180 by compressing against, and sealing against, intermediate lateral surface 182 and against intermediate vertical surface 184. A bottom radially outer edge 166 of the lower gasket 160 can be rounded, beveled, chamfered, or angled to ensure that the flat bottom and radially outer sides of the lower gasket 160 flatly contact the surfaces 182, 184 without the corner of the lower gasket 160 interfering with their engagement, especially if the corner is not completely consistent in shape. In some examples, the container housing 172 can include a rounded/filleted corner where the edge 166 is positioned in FIG. 4.

In some cases, outer surface 154 of sample material 148 can come short of contacting intermediate vertical surface 184 of shelf 180. Otherwise stated, in some cases, an air gap, space, or void, can reside between outer surface 154 and intermediate vertical surface 184 of shelf 180, despite the gaskets 132, 160 being in a compressed state.

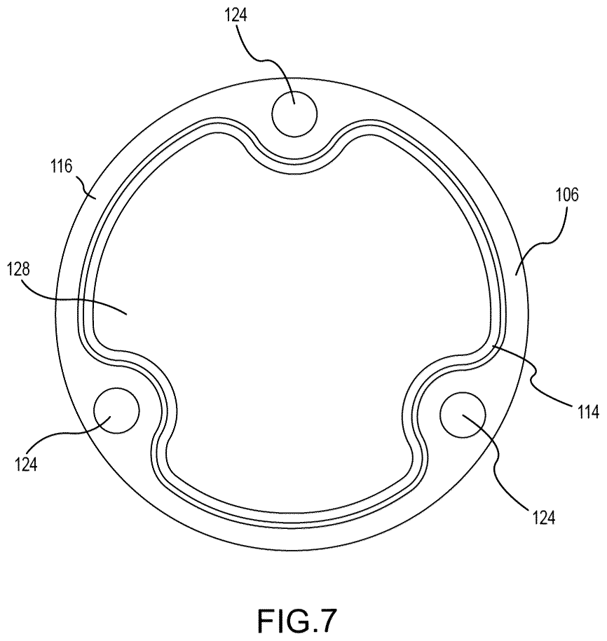

FIG. 7 illustrates a bottom view of ridge ring 114 of retaining ring 106. The ridge ring 114 can extend around an entire interior perimeter or inner circumferential surface 113 of retaining ring 106. In some cases, ridge ring 114 can circumscribe the through hole(s) 124 of retaining ring 106. Such a feature can allow for compression screws to pass through the assembly while maintaining a hermitic seal around the screws. Additionally, the gaskets 132, 160 can circumscribe the through holes 124, 156 of the retaining ring 106 and sample material 148 to circumferentially hermetically seal the holes and eliminate leakage where the compression screws 104 are located and penetrate the other components of the upper assembly. The threaded holes 178 can have top openings and closed bottom ends. The closed bottom ends can prevent leakage through the bottom of the container housing 172. In some examples, the threaded holes 178 can be through-holes, such as the through-holes shown in container housing 272. See FIG. 9. Through-hole threaded holes 178 can save weight and reduce material in the container housing 172.

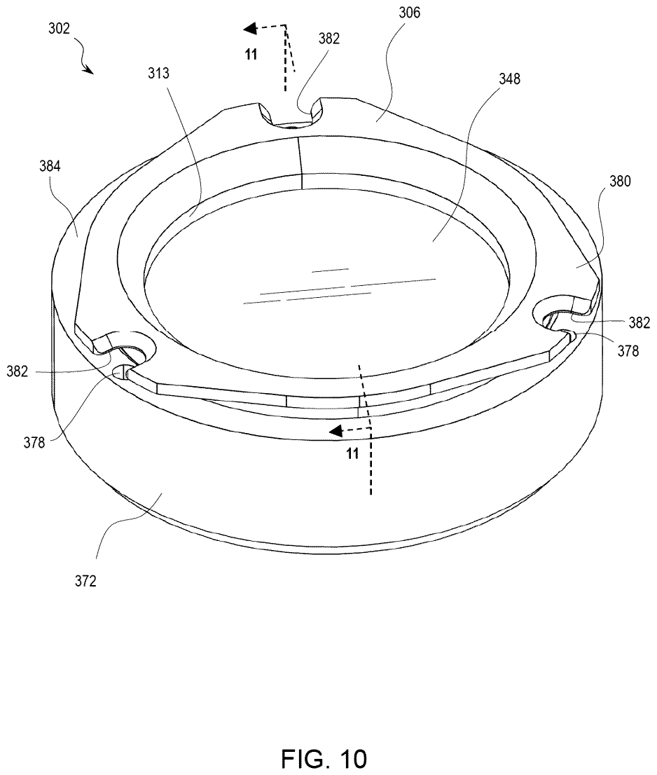

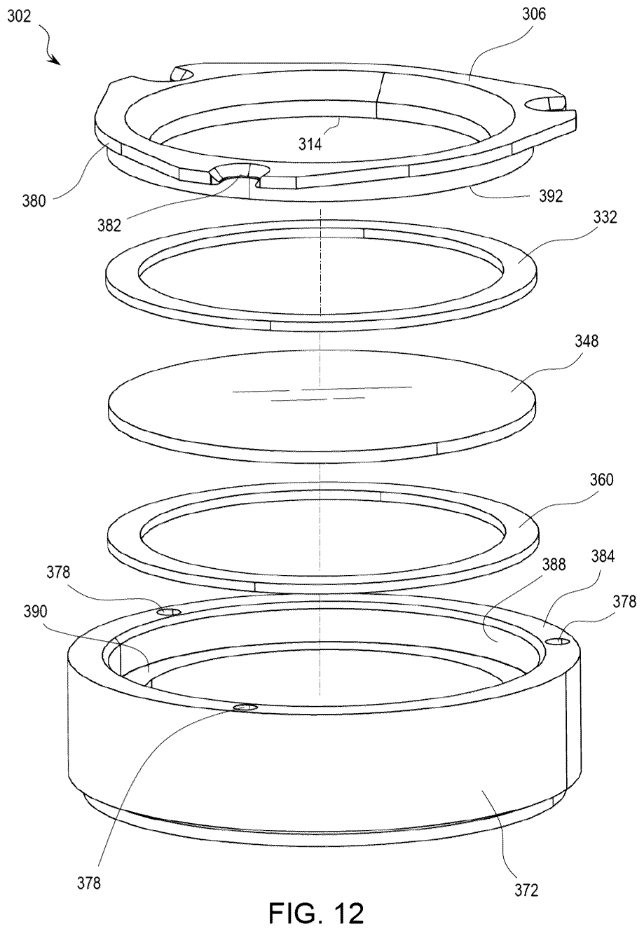

The ridge ring 114 can be non-circular, as shown in FIG. 7, with portions that are concentric with the outer perimeter of the retaining ring 106 and portions that extend radially inward relative to the concentric portions. The portions extending radially inward can coincide with the through holes 124 to ensure that the seal provided by the upper gasket 132 is consistent around the through holes 124 in addition to being consistent around the intermediate lateral surface 116. In some examples, the sample material, ridge ring, and gaskets can all be circular. See FIGS. 10-12.

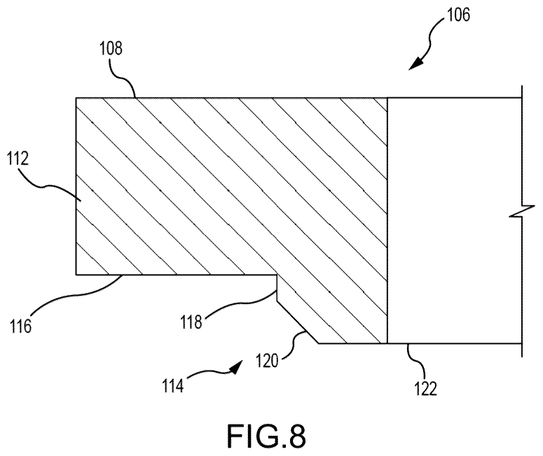

FIG. 8 illustrates a side section view of retaining ring 106. Retaining ring 106 may include an intermediate angled surface 120, an intermediate vertical surface 118, and an intermediate lateral surface 116, each configured to at least partially engage with and contact upper gasket 132 when the retaining ring 106 is installed. Upon assembly, intermediate lateral surface 116 can provide a downward compressive force, or form a lateral seal onto the upper gasket's face contacting intermediate lateral surface 116. Simultaneously, intermediate vertical surface 118 and/or intermediate angled surface 120 can provide a radially outward force against an inner circumferential surface of the upper gasket 132. Through such a geometry and configuration, retaining ring 106 and ridge ring 114 can influence the gasket in contact with it to expand radially outward, and form a seal against the shelf 180 and/or the container housing 172. The vertical height dimensions of the intermediate vertical surface 118 and the intermediate angled surface 120 can be configured to collectively be less than the compressed vertical height dimension of the upper gasket 132. Thus, as shown in FIG. 6, the ridge ring 114 may remain out of contact or spaced above the top surface of the sample material 148 after installation of the retaining ring 106. Keeping the ridge ring 114 out of contact with the sample material 148 can eliminate unwanted deformation or movement of the sample material 148, thereby improving sealing security and WVTR measurement consistency. Keeping the ridge ring 114 out of contact with the sample material 148 can also help maximize the exposed surface of the sample material and the vapor transmission surface area of the sample material 148.

FIG. 9 illustrates an embodiment of a container 202 comparable to container 102 described in connection with FIGS. 1-8. Accordingly, like features are designated with like reference numerals, with the leading digits incremented to “2”. Thus, except as set forth below, retaining ring 206 may have functions and features in common with retaining ring 106 and likewise for the container housing 272 (for container housing 172), sample material 248 (for sample material 148), and gasket 232 (for upper gasket 232). Relevant disclosure set forth above regarding similarly identified features thus may not be repeated hereafter. Moreover, specific features of container 102 and related components shown in FIG. 1-8 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of container 202 and related components depicted in FIG. 9.

Any suitable combination of the features, and variations of the same, described with respect to container 102 and related components illustrated in FIG. 1-8 can be employed with container 202 and related components depicted in FIG. 9, and vice versa. This pattern of disclosure applies equally to further embodiments depicted in subsequent figures and described hereafter, wherein the leading digits may be further incremented.

FIG. 9 illustrates an exploded view of an example embodiment of a container 202. Container 202 includes an upper assembly comprising a retaining ring 206, an upper gasket 232, and a sample material 248) which rests on, is pressed onto, or is otherwise inserted into a shelf of container housing 272 (equivalent to shelf 180).

Upon being pressed into container housing 272 via compression screws or other fasteners, the edges of sample material 248 can be hermetically sealed using upper gasket 232. Thus, the retaining ring 206 can be pressed down onto upper gasket 232 to compress the upper gasket 232 into hermetic sealing contact with an intermediate vertical surface (e.g., 184) of the container housing 272 and into hermetic sealing contact with an intermediate lateral surface (e.g., 116) of retaining ring 106. The sample material 248 may be pressed downward onto the shelf (e.g., 180/surface 182) without a lower gasket 160 between the sample material 248 and the shelf. The sample material 248 can therefore be sealed by the upper gasket 232 around its circumference in at least two directions: laterally and vertically. In this manner, the sample material 248 can be sealed in the container 200 using fewer components than sample material 148 of system 100. The omission of a lower gasket (e.g., 160) can simplify the design and can save on costs of the apparatus and may be suitable for certain sample materials 248 that do not require a lower gasket (e.g., 160) for pressure distribution, additional sealing, or additional support. Omitting a lower gasket can also allow the system to accommodate a thicker sample material, provided that a seal can be achieved without the lower gasket with the thicker sample material. Similarly, the compression can be configured to seal an outer surface, or a combined outer surface of the components of the upper portion, by an inner surface of container housing 272.

In some cases, a ridge ring 214 of retaining ring 206 can be noncontiguous, or be composed from circumferential segments 215A, 215B, 215C. The circumferential segments 215A, 215B, 215C may collectively urge the upper gasket 232 laterally outward, similar to ridge ring 114. The ridge ring 214 may have circumferential gaps adjacent to the positions where screws are installed through the retaining ring 206, as shown in FIG. 9 between each pair of circumferential segments 215A, 215B. For certain gaskets or sample materials, such as gaskets 232 with high elasticity, the ridge ring 214 may not need to laterally/radially urge the entire inner perimeter of the gasket outward.

FIGS. 10-12 illustrate further features of embodiments of the present disclosure. An example system can include a container 302 with a retaining ring 306 attachable to a container housing 372 to hold a sample material 348 in position for WVTR testing. The housing 302 can have the features and characteristics of other housings disclosed herein (e.g., 102, 202). Thus, the container 302 can include a container housing 372 configured to hold a moisture-containing or dessicant material within an internal chamber 374 while holding and sealing a sample material 348 using the retaining ring 306. The sample material 348 can be exposed to the testing chamber environment through a central opening 313 of the retaining ring 306.

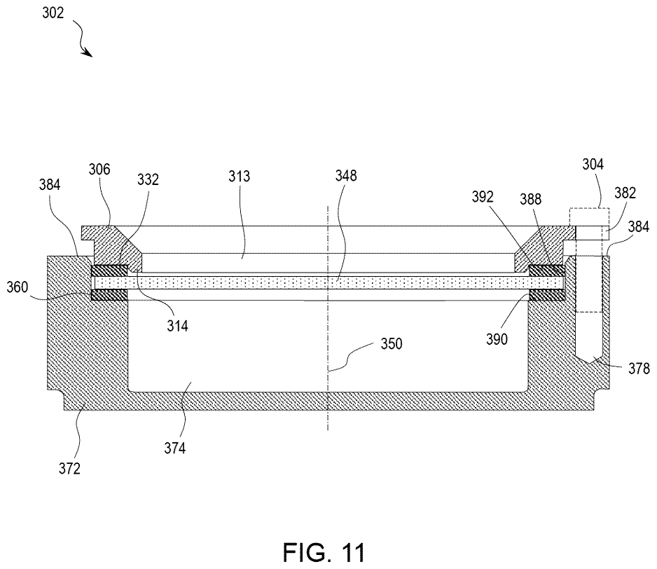

The retaining ring 306 can be affixed to the container housing 372 via screws (e.g., 104 or 304 in FIG. 11), similar to other embodiments described herein. The screws can be inserted into threaded holes 378 defined in the container housing 372. The screws can also extend through a top flange 380 of the retaining ring 306 that has a set of open-ended slots 382 for receiving the screws. Three (or more) open-ended slots 382 can correspond to three (or more) screws used to fasten the retaining ring 306 to the container housing 372. The threaded holes 378 can be blind holes (with closed inner ends) or through-holes (with two open ends). A through-hole configuration can save weight and material in the finished assembly. The threaded holes 378 can extend inward to the container housing 372 through an outer top surface 384 of the container housing 372. The outer top surface 384 can be a top-most surface of the container housing 372 when the container 302 is positioned in a testing chamber. With the threaded holes 378 positioned in the outer top surface 384, the screws 304 do not need to extend through the sample 348 or gaskets 332, 360. If the screws 304 do not extend through the sample 348 or gaskets 332, 360, the construction and assembly of the container 302 is simplified and requires fewer steps, e.g., there is no need for cutting openings (e.g., 156) in the sample material 348 or aligning openings (e.g., 168) of the gaskets with the threaded holes 378.

The container 302 can include a lower gasket 360 and an upper gasket 332 positioned on opposite (e.g., top and bottom) sides of the sample material 348, as shown in the side cross-sectional view of FIG. 11. The gaskets 332, 360 can therefore seal the surfaces and perimeter of the sample material 348 to ensure that any vapor transmission into or out of the internal chamber 374 passes exclusively through the sample material 348. As with other embodiments described herein, the gaskets 332, 360 can comprise the materials of gaskets 132, 160, and 232, and the gaskets 332, 360 can seal against (and prevent fluid exchange past the gaskets 332, 360 at) a radially outer wall 388 (similar to intermediate vertical surface 184), a shelf 390 (similar to intermediate lateral surface 182), and a downward/inward-facing surface 392 of the retaining ring 306. Furthermore, as in other embodiments, the compressive pressure applied by the retaining ring 306 (including at surfaces equivalent to intermediate vertical surface 118 and intermediate angled surface 120, as shown in FIG. 8) can compress the gaskets 332, 360 radially and laterally outward into the radially outer wall 388 (i.e., away from central vertical axis 350) to ensure a consistent outer circumferential seal.

The ridge ring 314 of the retaining ring 306 can form a continuous circle around the opening through the upper gasket 332. With a continuous circular ridge ring 314, the upper gasket 332 can be simple to install around the retaining ring 306 by inserting the ridge ring 314 into the upper gasket 332 before installing the retaining ring 306 to the container housing 372. The continuity of the ridge ring 314 can also provide consistent pressure against the inner opening of the upper gasket 332 so that the upper gasket 332 is evenly stretched or pressed radially outward around the entire inner perimeter of the upper gasket 332, thereby leading to consistent sealing at the outer perimeter of the upper gasket 332 and at the downward/inward-facing surface 392.

In some examples, the container 302 can omit one of the gaskets, such as the lower gasket 360. The container 302 can then accommodate a thicker/taller sample material 348 against the shelf 390 while using the upper gasket 332 to ensure sealing around the perimeter of the sample material 348. Omitting a gasket can reduce part count and assembly and manufacturing costs. Using a double seal “sandwiching” the sample material 348 can provide improved reliability through redundancy while accommodating and providing improved surface support for thinner sample materials 348.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

One aspect of the disclosure relates to a container for testing a water vapor transmission rate (WVTR) of a sample material. The container may comprise: a container housing defining an internal chamber; a retaining ring attached to the container housing and configured to retain a sample material between the retaining ring and the container housing; and a first gasket disposed between the retaining ring and the container housing and configured to be disposed against an upper surface of the sample material. The retaining ring may be configured to compress the first gasket in a first direction against the retaining ring and in a second direction against the container housing in response to attachment of the retaining ring to the container housing.

In some examples, the first direction is a vertical direction, and the second direction is a lateral or radial direction.

In some examples, the retaining ring comprises an intermediate lateral surface configured to compress the first gasket in the first direction and an intermediate vertical surface configured to compress the first gasket in the second direction.

In some examples, the container housing comprises a shelf comprising an intermediate lateral surface configured to compress the first gasket in the first direction and an intermediate vertical surface configured to compress the first gasket in the second direction.

In some examples, the shelf extends around the perimeter portion of the container housing.

In some examples, the first gasket comprises a first outer diameter when in an uncompressed state and a second outer diameter when compressed by the retaining ring, wherein the first outer diameter is smaller than the second outer diameter.

In some examples, the retaining ring is further configured to compress the first gasket into the container housing so as to hermetically seal an outer circumferential surface of the sample material from the environment.

In some examples, the container further comprises a second gasket disposed between the retaining ring and the container housing, with the second gasket configured to be disposed against a lower surface of the sample material.

Another aspect of the disclosure relates to a support fixture for testing a water vapor transmission rate (WVTR) of a sample material, comprising: a support fixture body defining an internal cavity; a retainer disposed on an upper portion of the support fixture body and configured to retain a sample material; and a first sealing member disposed between the retainer and the support fixture body and configured to be disposed against an upper surface of the sample material. The first sealing member and the support fixture body may seal a perimeter portion of the sample material in three dimensions.

In some examples, the retainer compresses the first sealing member.

In some examples, the first sealing member is configured to expand laterally due to being compressed by the retainer.

In some examples, the first sealing member and the support fixture body seal a perimeter portion of the sample material around a perimeter portion of the retainer.

In some examples, the first sealing member contacts an intermediate surface of the retainer, the intermediate surface extending downward from the retainer.

In some examples, the first sealing member and the support fixture body form a vertical seal between an outer circumferential surface of the first sealing member and an inner circumferential surface of the support fixture body.

In some examples, the first sealing member is laterally sealed between a lateral surface of the retainer and a lateral surface of the support fixture body.

In some examples, the support fixture further comprises a second sealing member disposed between the retainer and the support fixture body, wherein the second sealing member is configured to be disposed against a lower surface of the sample material.

In some examples, the second sealing member is laterally sealed between the lateral surface of the support fixture body and a lateral surface of the second sealing member.

Yet another aspect of the disclosure relates to a system for testing a water vapor transmission rate (WVTR) of a sample material comprising: a testing apparatus including a chamber, wherein the testing apparatus is configured to control relative humidity in the chamber; a container configured to retain a sample material and at least one of a desiccant or a water source, the container comprising: a housing defining an internal chamber; a compression ring disposed on an upper portion of the container housing and configured to retain a sample material; and an elastic ring disposed between the compression ring and the housing, wherein the elastic ring is configured to be disposed against a top surface of the sample material.

The elastic ring and the housing may be configured to hermetically seal a perimeter portion of the sample material in three perpendicular directions. In some examples, the elastic ring laterally expands against the housing in response to a vertical compressive force applied by the compression ring.

What is claimed is:

1. A container for testing a water vapor transmission rate (WVTR) of a sample material, the container comprising:
a container housing defining an internal chamber;
a retaining ring attached to the container housing and configured to retain a sample material between the retaining ring and the container housing;
a first gasket disposed between the retaining ring and the container housing and configured to be disposed against an upper surface of the sample material;
wherein the retaining ring is configured to compress the first gasket in a first direction against the retaining ring and in a second direction against the container housing in response to attachment of the retaining ring to the container housing.

2. The container of claim 1, wherein the first direction is a vertical direction, and the second direction is a lateral or radial direction.

3. The container of claim 1, wherein the retaining ring comprises an intermediate lateral surface configured to compress the first gasket in the first direction and an intermediate vertical surface configured to compress the first gasket in the second direction.

4. The container of claim 1, wherein the container housing comprises a shelf comprising an intermediate lateral surface configured to compress the first gasket in the first direction and an intermediate vertical surface configured to compress the first gasket in the second direction.

5. The container of claim 4, wherein the shelf extends around a perimeter of the container housing.

6. The container of claim 1, wherein the first gasket comprises a first outer diameter when in an uncompressed state and a second outer diameter when compressed by the retaining ring, wherein the first outer diameter is smaller than the second outer diameter.

7. The container of claim 1, wherein the retaining ring is further configured to compress the first gasket into the container housing so as to hermitically seal an outer circumferential surface of the sample material from an environment external to the container housing.

8. The container of claim 1, further comprising a second gasket disposed between the retaining ring and the container housing, the second gasket configured to be disposed against a lower surface of the sample material.

9. A support fixture for testing a water vapor transmission rate (WVTR) of a sample material, comprising:
a support fixture body defining an internal cavity;
a retainer disposed on an upper portion of the support fixture body and configured to retain a sample material;
a first sealing member disposed between the retainer and the support fixture body and configured to be disposed against an upper surface of the sample material;
wherein the first sealing member and the support fixture body seal a perimeter portion of the sample material in three dimensions.

10. The support fixture of claim 9, wherein the retainer compresses the first sealing member.

11. The support fixture of claim 9, wherein the first sealing member is configured to expand laterally due to being compressed by the retainer.

12. The support fixture of claim 9, wherein the first sealing member and the support fixture body seal a perimeter portion of the sample material around a perimeter portion of the retainer.

13. The support fixture of claim 9, wherein the first sealing member contacts an intermediate surface of the retainer, the intermediate surface extending downward from the retainer.

14. The support fixture of claim 9, wherein the first sealing member and the support fixture body form a vertical seal between an outer circumferential surface of the first sealing member and an inner circumferential surface of the support fixture body.

15. The support fixture of claim 9, wherein the first sealing member is laterally sealed between a lateral surface of the retainer and a lateral surface of the support fixture body.

16. The support fixture of claim 9, further comprising a second sealing member disposed between the retainer and the support fixture body, wherein the second sealing member is configured to be disposed against a lower surface of the sample material.

17. The support fixture of claim 16, wherein the second sealing member is laterally sealed between a lateral surface of the support fixture body and a lateral surface of the second sealing member.

18. A system for testing a water vapor transmission rate (WVTR) of a sample material comprising:
a testing apparatus including a chamber, wherein the testing apparatus is configured to control relative humidity in the chamber;
a container configured to retain a sample material and at least one of a desiccant or a water source, the container comprising:
a housing defining an internal chamber;
a compression ring disposed on an upper portion of the container and configured to retain a sample material;
an elastic ring disposed between the compression ring and the housing, wherein the elastic ring is configured to be disposed against a top surface of the sample material;
wherein the elastic ring and the housing are configured to hermetically seal a perimeter portion of the sample material in three perpendicular directions.

19. The system of claim 18, wherein the elastic ring laterally expands against the housing in response to a vertical compressive force applied by the compression ring.
